(19) United States
(12) Patent Application Publication
(10) Pub. No.: US 2007/0231562 A1
(43) Pub. Date: Oct. 4, 2007

(54) Heat-dissipating accessory plate for high speed drilling

(75) Inventor: Ming-Cheng Hsiao, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: Uniplus Electronics Co., Ltd.

(21) Appl. No.: 11/498,880

(22) Filed: Aug. 4, 2006

(30) Foreign Application Priority Data
Apr. 3, 2006 (TW) 095111843

(51) Int. Cl. B32B 27/20; B32B 15/04; B32B 27/30

(52) U.S. Cl. 428/323; 428/457; 428/522; 428/411.1; 428/500; 428/484.1; 428/331; 428/328; 428/329

(57) ABSTRACT

A heat-dissipating accessory plate for high speed drilling, prepared by adhering a composite material which is a solid state, abrasion-resistant, lubricating coating comprised of nano-structure powder and a high heat-conducting compound, over a supporting material, and then covering a lubricating layer over said composite material, can provide an action of grinding and lubricating a drill bit as well as dissipate heat generated during drilling processing on a printed circuit board.

### BACKGROUND OF THE INVENTION

1. Field of the Invention

The invention relates to a cover plate useful for printed circuit board (PCB), and more particularly to a heat-dissipating accessory plate for high speed drilling comprised of a composite material, it can exhibit actions of grinding, lubricating drilling bit and heat conducting during drilling processing.

2. Description of the Prior Art

In recent years, as the electronic technology progresses with each passing day, and many high technical industries develops successively, a great number of more humanized new electronic products having better functions have been developed constantly toward a trend of lower weight, thinner, shorter and smaller size. Every electronic product has generally at least one main board comprised of many electronic elements and circuit board. The function of a circuit board comprises of supporting and electrically connecting electronic elements so that those electronic elements can function properly. Currently, circuit boards most commonly used are printed circuit board (PCB).

A printed circuit board can link electronic components together such that the integral function of these electronic components electrically connected can be realized. Therefore, PCB is an indispensable fundamental element in all of the electronic informational products. Since printed circuit board may have uneven, some good and some bad designs, which may not only affect directly the reliability of an electronic product, but also can influence the competitiveness of a system product, it is often referred as “the mother of an electronic system product” or “the base of 3C industry”. PCB is a flat board made of a non-conducting material. On this board, there is intended to drill holes for mounting chips or other electronic elements. These holes for elements can facilitate the electrical connecting of defined metal routes previously printed over the board, whereby connecting legs of these electronic elements penetrate PCB, and are adhered then on the PCB with conducting metal solder to form an electrical circuit.

However, during drilling the circuit board, for holes of small diameter, a correspondingly small drill bit must be used, which, consequently, results in frequent drill bit breaking. The common method for drilling holes on PCB is that PCB comprises a aluminum cover plate (as shown in FIG. 3) in order to buffer the drill bit and dissipate heat therefrom during drilling. Said aluminum cover plate (3) is generally consisted of an aluminum foil (32), a porous fiber layer (31) and a lubricating layer (33).

Further, during drilling, since the porous fiber layer (31) is in solid state and insoluble, borings produced in the drilling hole often breaks the drill bit or roughens the inner wall of the drill hole in the PCB.

Furthermore, since the rotational rate of the drill bit must be increased in order to accelerate the drilling speed, and as the result, the porous fiber layer (31) is fail to dissipate efficiently the heat produced by the drill bit (4) in the friction of such high speed drilling, the use life of the drill bit might be reduced consequently.

Moreover, during drilling, the insufficient lubrication of the drill bit (4) by the aluminum foil (32) of said aluminum cover plate (3) tends to result in scattering a lot of metal borings over the PCB under the high speed drilling. These borings might, if not cleaned up, incur an electrical short-circuit in the use of the PCB, and hence affect the reliability of the product.

### SUMMARY OF THE INVENTION

One objective of the invention is to provide a heat-dissipating accessory plate for high speed drilling on PCB, it has simple composition and low cost.

Another objective of the invention is to provide a heat-dissipating accessory plate for high speed drilling, it can provide both actions of grinding and lubricating the drill bit during drilling.

The another objective of the invention is to provide a heat-dissipating accessory plate for high speed drilling, it can avoid the roughening of the inner wall of the drill hole or the breaking of the drill bit.

Still another objective of the invention is to provide a heat-dissipating accessory plate for high speed drilling, it can conduct efficiently heat from the drill bit.

In order to achieve the above-mentioned objectives of the invention, the heat-dissipating accessory plate for high speed drilling according to the invention comprises a supporting material, a composite material and a lubricating layer, wherein said composite material is a solid state, abrasion-resistant lubricating coating consisted of nano-structure powder and a highly heat-conducting compound, the said composite material is adhered on said supporting material, and said lubricating layer is coated over said composite material, thereby during drilling process, the purpose of the lubrication and heat dissipation of the drill bit can be achieved by means of the above-described heat-dissipating accessory plate for high speed drilling.

In order to better understand the invention, it will be described more detail with reference of the following embodiments.

### BRIEF DESCRIPTION OF THE DRAWINGS

FIG. 1 is a sectional view of a heat-dissipating accessory plate for high speed drilling of the invention;

FIG. 2 is a sectional view illustrating the use of a heat-dissipating accessory plate for high speed drilling of the invention on the PCB during drilling; and

FIG. 3 is a sectional view of a drilling cover plate of prior art.

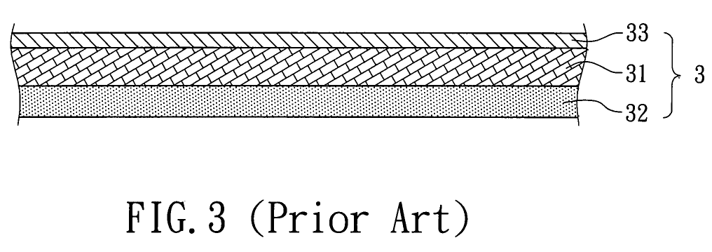

### DETAILED DESCRIPTION OF THE PREFERRED EMBODIMENTS

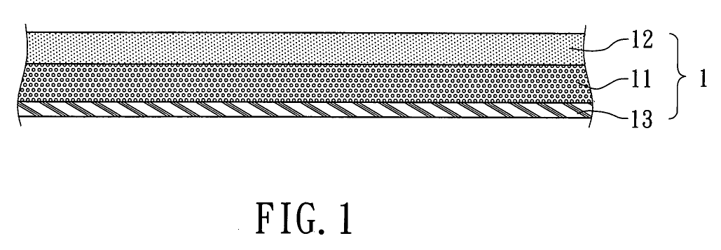

Referring to FIG. 1, a heat-dissipating accessory plate for high speed drilling (1) according to one preferred embodiment of the invention comprises a supporting material (13), a composite material (11) and a lubricating layer (12).

Said composite material (11) is a solid state, abrasion-resistant lubricating coating consisted of nano-structure powder and a highly heat-conducting compound, wherein said composite material is adhered on said supporting material (13). In a preferred embodiment of the invention, said nano-structure powder may be one or more powder selected from the group consisting of molybdenum disulfide (MoS₂) nano-particles, tungsten disulfide (WS₂) nano-particles, copper disulfide (CuS) nano-particles, aluminum oxide (Al₂O₃) nano-particles, lanthanide fluoride (LaF₃) nano-particles, silicon carbide (SiC) nano-particles, silicon nitride (Si₃N₄) nano-particles, silicon dioxide (SiO₂) nano-particles, borate nano-particles, and metal nano-powder. Said highly heat-conducting compound may be one or more compound selected from the group consisting of aluminum hydroxide (Al(OH)₃), boron nitride (BN) or aluminum nitride (AlN), which can dissipate the heat generated during the drilling process so as to reduce the effect of the friction heat generated during drilling on the material of the printed circuit board (2) and to extend the use life of the drill bit.

Said lubricating layer (12) is coated on the surface of the above-described composite material (11). In a preferred embodiment according to the invention, said lubricating layer (12) is one or more substances selected from the group consisting of nonyl phenol polyethylene glycol ether, polyethylene glycol (PEG), polyvinyl alcohol (PVA), polyacrylic acid and its salts thereof, poly methyl methacrylate (Perspex), cerotic acid, isopropyl cinnamate, glycerol monostearate, bee wax and mixture thereof.

Said supporting material (13) may be a plastic plate or a metal foil. In a preferred embodiment, said supporting material (13) is plastic material. Said supporting material (13) is used to support the above-described composite material (11) and lubricating layer (12). As borings produced from said supporting material (13) during drilling is, unlike conducting metal, electrical non-conducting, problems such as electrical short circuit or burn out during the use of a printed circuit board (2) can be avoided.

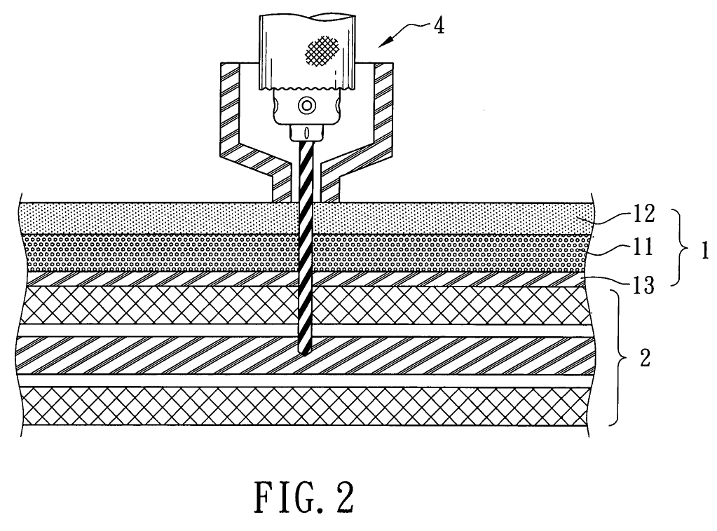

Thus, as shown in FIG. 2, in the practice of the invention, the thus finished heat-dissipating accessory plate for high speed drilling (1) is placed over the printed circuit board (2) to carry out drilling process. As the drilling apparatus reaches a pre-determined drilling position, the drill bit (4) is lowered and performs drilling operation. As the drill bit (4) is lowered, it will penetrate the lubricating layer (12) provided by the invention, whereby the drill bit (4) could be lubricated and its penetrating force could be buffered such that the deviation of a hole or breaking of drill bit can be avoided. As the drill bit (4) is lowered further, it will pass through the composite material (11) provided by the invention, wherein said composite material (11) is comprised of nano-structure powder and wherein, owing to the special structure from said nano-structure powder, there are four effects, namely, quantum-size effect, macro-quantum tunnel effect, surface effect and volume effect, and hence it can exhibit both features of lubrication and abrasion resistance, and can exert simultaneously actions of grinding and lubricating the drill bit (4) so as to keep the drill bit sharp. Meanwhile, the highly heat-conducting compound contained in the composite material can carry away in time the heat generated during high rotation of the drill bit (4).

When the drill bit is lowered further, it will penetrate through the supporting material (13) of the invention. In preferred embodiments according to the invention, said supporting material (13) is a plastic plate. As the drill bit penetrates through said supporting material (13), plastic borings thus generated is electrical non-conducting rather than electrical conducting like metal so that the short circuit or burnout occurred in the use of the printed circuit board (2) can be avoided.

Therefore, the invention has following advantages:
1. The invention provides a heat-dissipating accessory plate for high speed drilling suitable for drilling processing on a printed circuit board, it has a simple composition and low cost.
2. The invention provides a heat-dissipating accessory plate for high speed drilling, wherein its composite material comprises a highly conducting compound that can carry away the heat generated during drilling so as to achieve the heat dissipating effect.
3. The invention provides a heat-dissipating accessory plate for high speed drilling, wherein its composite material comprises nano-structure powder that can grind and lubricating the drill bit during drilling.
4. The invention provides a heat-dissipating accessory plate for high speed drilling, characterized in that, with its structure comprising a solid state abrasion-resistant lubricating layer, it can avoid the generation of borings during drilling, and hence can prevent the inner wall of the drilled part from roughening as well as can avoid the breaking of the drill bit.
5. The invention provides a heat-dissipating accessory plate for high speed drilling, wherein it comprises a supporting material characterized in that said supporting material is a plastic plate that can not only decrease effectively the production cost, but also, owing to its electrical non-conducting feature, the metal borings generated from the prior art drilling cover plate can be eliminated, that is, during drilling processing, no such metal borings would be produced and hence no electrical short circuit would take place. Further, even if the supporting material used in the heat-dissipating accessory plate according to the invention comprises a metal foil, the drilling hole can achieve good lubrication by virtue of the double-layer lubrication design based on both of the lubricating layer and the solid state abrasion-resistant lubricating coating, such that, during drilling, metal borings can be prevent from sputtering around.

Accordingly, based on the above disclosure and drawings, the objectives according to the invention can be achieved by providing a heat-dissipating accessory plate for high speed drilling characterized in that it can avoid the generation of borings during drilling processing and meanwhile can conduct and dissipate heat generated. While the invention has been described with reference to embodiments and technical means thereof, various change and modification can be made based on the disclosure or teachings described herein. Those equivalent change made based on technical means of the invention having their effect without departing from the spirit encompassed by the specification and drawings are intended to be fallen within the scope of the invention defined only by the appended claims.

What is claimed is:

1. A heat-dissipating accessory plate for high speed drilling, useful placing over a printed circuit board during drilling, comprises:
a composite material, which is a solid state, abrasion-resistant lubricating coating consisted of nano-structure powder and a highly heat-conducting compound;
a supporting material, for adhering and supporting said composite material, and
a lubricating layer, provided over the surface of said composite material;
whereby, during drilling processing on the printed circuit board, said drill bit can be ground and lubricated, while the heat generated can be dissipated.

2. The heat-dissipating accessory plate for high speed drilling as claimed in claim 1, wherein said supporting material is a plastic plate.

3. The heat-dissipating accessory plate for high speed drilling as claimed in claim 1, wherein said supporting material is a metal foil.

4. The heat-dissipating accessory plate for high speed drilling as claimed in claim 1, wherein said lubricating coating is one or more substances selected from the group consisting of nonyl phenol polyethylene glycol ether, polyethylene glycol (PEG), polyvinyl alcohol (PVA), polyacrylic acid and salts thereof, poly methyl methacrylate (Perspex), cerotic acid, isopropyl cinnamate, glycerol monostearate, bee wax and mixture thereof.

5. The heat-dissipating accessory plate for high speed drilling as claimed in claim 1, wherein said highly heat-conducting compound is one or more compound selected from the group consisting of aluminum hydroxide (Al(OH)₃), boron nitride (BN) and aluminum nitride (AlN).

6. The heat-dissipating accessory plate for high speed drilling as claimed in claim 1, wherein said nano-structure powder is one or more powder selected from the group consisting of molybdenum disulfide (MoS₂) nano-particles, tungsten disulfide (WS₂) nano-particles, copper disulfide (CuS) nano-particles, aluminum oxide (Al₂O₃) nano-particles, lanthanide fluoride (LaF₃) nano-particles, silicon carbide (SiC) nano-particles, silicon nitride (Si₃N₄) nano-particles, silicon dioxide (SiO₂) nano-particles, borate nano-particles, and metal nano-powder.
